(19) United States
(12) Patent Application Publication
(10) Pub. No.: US 2011/0161167 A1
(43) Pub. Date: Jun. 30, 2011

(54) Social media platform for providing interactive services

(76) Inventor: Srikanth Jallapuram, Cupertino, CA (US)

(21) Appl. No.: 12/981,774

(22) Filed: Dec. 30, 2010

Related U.S. Application Data
(60) Provisional application No. 61/291,343, filed on Dec. 30, 2009.

(51) Int. Cl. G06Q 30/00; G06F 3/01

(52) U.S. Cl. 705/14.49; 715/738

(57) ABSTRACT

Embodiments herein provide for a social media platform through a service delivery platform (SDP) using which users or group of users can plan and schedule consumption of services, and plan and manage events. Embodiments herein allow for automatic integration of SDP with user calendar information and user profile information to enable efficient and effective planning of day to day activities. Users and service providers may register themselves in the SDP, and the SDP provides a social media platform for users to engage and transact.

This application claims the benefit of U.S. Provisional Application No. 61/291,343, filed Dec. 30, 2009.

### TECHNICAL FIELD

The embodiments herein relate to social media platforms and, more particularly, to social media platforms that enable interactive services between consumers and service providers.

### BACKGROUND

Online commerce has been steadily increasing over the past decade or so. With rapid technological advancements in telecommunications, it is now possible to access internet and consume services using a mobile phone while a user is on the move.

Social media platforms are based on media created and disseminated by users through social interaction. Some examples of social media include blogs, social networking, social bookmarking, social news, wikis, photo sharing, video sharing, product reviews, business reviews, and so on. Social networks are based on various inter-relationships between users. Existing social network platforms try to connect users based on one or more specific types of interdependencies, such as friendship, family, sexual orientation, social status, business relationships, and so on. Social networks are not generally based on connecting consumers and service providers.

Social media platforms are influencing the way consumers are behaving. Users typically use social media to interact with their networks and get feedback on various services they might be interested in. Using the feedback and information that they obtain about various services, users typically search for the services that they feel suit their needs better.

While there are mechanisms for consumers to get feedback on services using their online networks, and for buying services online, there are no mechanisms for consumers to stay “connected” and interact with the services that they might be using regularly or might want to use in the future.

Current generation of mobile Internet services usually serve a specific segment or a specific area of need for Internet & Mobile Internet Consumers. Services offered are narrow in scope and are disjoint from other service offerings, in the sense that users are required to search for specific services based on his needs even though a user might be using the same service on a regular basis. Social media platforms including social networking platforms are not designed for bringing consumers and service providers together.

Further, the existing Social Media solutions lack Enterprise interfaces providing services both to Consumers as well as to the Mobile Users. Some social networking platforms allow for users (both consumers and service providers) to create applications that serve their specific needs. Using such application based platforms, it is possible for service providers to engage consumers in a limited way. However, with the number of platforms available increasing rapidly, it is very difficult for service providers to create their own application every time they want to interact with users belonging to a particular social media platform.

### BRIEF DESCRIPTION OF THE FIGURES

The embodiments herein will be better understood from the following detailed description with reference to the drawings, in which:

FIG. 1 illustrates a network incorporating a Social Media Platform, according to embodiments as disclosed herein;

FIG. 2 depicts a SDP, according to embodiments as disclosed herein;

FIG. 3 depicts a communication link between the SDP and a client (user/service provider), according to embodiments as disclosed herein;

FIG. 4 illustrates a user profile, according to embodiments as disclosed herein;

FIG. 5 shows an example user registration page according to embodiments as disclosed herein;

FIG. 6 shows an example user home page according to embodiments as disclosed herein;

FIG. 7 shows an example user home page according to embodiments as disclosed herein;

FIG. 8 shows an example service search page according to embodiments as disclosed herein;

FIG. 9 illustrates queuing of services through service carousel according to embodiments as disclosed herein;

FIG. 10 shows an example service provider registration page according to embodiments as disclosed herein;

FIG. 11 shows an example service management page according to embodiments as disclosed herein;

FIG. 12 illustrates service provider profile according to embodiments as disclosed herein;

FIG. 13 illustrates reservation management capability of the SDP system according to embodiments as disclosed herein;

FIG. 14 shows an example service provider reservation management interface according to embodiments as disclosed herein;

FIG. 15 shows message flow in a reservation management example according to embodiments as disclosed herein;

FIG. 16 illustrates trip planning capability of the SDP system according to embodiments as disclosed herein;

FIG. 17 shows message flow in an event management example according to embodiments as disclosed herein; and

FIG. 18 shows an event management interface according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

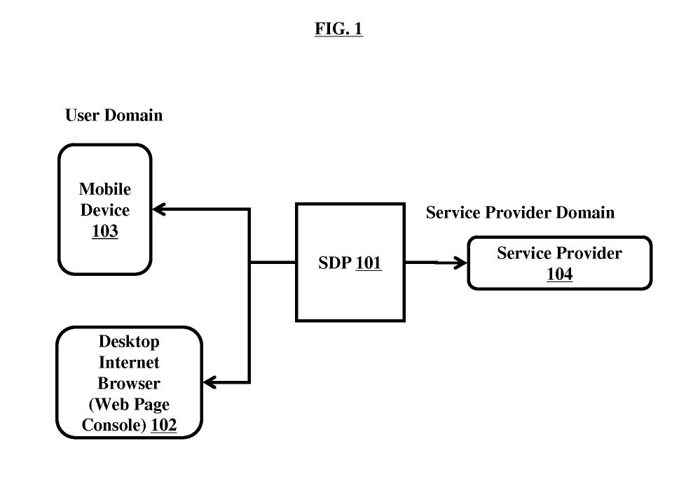

The embodiments herein disclose a system for permitting internet & mobile internet users to access Internet resources & services (day to day services) more efficiently. Referring now to the drawings, and more particularly to FIGS. 1 through 18, where similar reference characters denote corresponding features consistently throughout the figures, there are shown embodiments.

### System Embodiments

FIG. 1 illustrates a network incorporating a Social Media Platform, according to embodiments as disclosed herein. The network as depicted comprises of a Service Delivery Platform 101, a user domain and a service provider domain. The user domain and the service provider domain may be connected to the SDP 101 using web services. The user domain and the service provider domain may also be connected to the SDP 101 using any other suitable communication means such as a mobile network. The user domain further comprises of a user access means like a mobile device 103 and a web console 102. The user may access the SDP 101 using the mobile device 103 using any suitable internet connection means such as 3G, LTE, GPRS, EDGE or any available internet access means. The user may also access the SDP 101 using a web console 102, which may be present on any computing device such as a computer, handheld device and so on. The web console 102 may connect to the SDP 101 using any available internet connection means such as a wireless network, a wired network, LAN, a dial-up connection and so on. The service provider domain comprises of at least one service provider 104, where the service provider 104 may be a SMB (Small to Medium Business), an enterprise or an individual vendor. The service provider 104 may be a restaurant, a cinema theater, a salon, a carpenter, a plumber, a legal service provider, a neighborhood store and so on. The service provider 104 may access the SDP 101 using any suitable device capable of connecting to the internet, which may be a mobile device or a web console. The device may connect to the SDP 101 using 3G, LTE, GPRS, EDGE, a wireless network, a wired network, LAN, a dial-up connection and so on.

The SDP 101 provides a web interface which allows the Mobile/Internet users or groups of users to access services and utilize them as deemed appropriate. The SDP 101 enables service providers 104 to register themselves and create their services. Assuming a fairly large list of services is created by various service providers 104, the system indexes these services based on several parameters. The indexing parameters may be static parameters or dynamic parameters. The static parameters may comprise of parameters like Category of Service, Location, Cost, Best Rated Service and several such configurable parameters. The dynamic parameters comprise of parameters like Service Wait Time at a Restaurant, seats available at a cinema theater and so on.

Further, the SDP 101 uses unique individual identifiers, such as the popular name of a service, as the primary search keyword to access mobile internet resources & services and selectively access additional internet resources as desired by the user. Using the SDP 101, the user may also perform various functions such as selecting and scheduling for a service, with a single selection. This permits users to receive search results of services based on preferences and his locations very quickly and the services are ready for use.

The SDP 101 allows the users to share media of their choice like images/pictures, video clips and any document of their choice that they would like to share with the rest of their social network. It is also important to note that while the user(s) are able to create events, create documents of their choice online, upload art of their choice, participate in consuming a service using this portal, he has an ability to choose whether he would like share these events/objects/documents & service related ratings with the rest of his social network. The user is also able to take pictures or shoot video from his mobile device and directly upload the images & video clips with smart tags, location information directly into the SDP 101 for the rest of his social network to immediately view the content shared by him in real time.

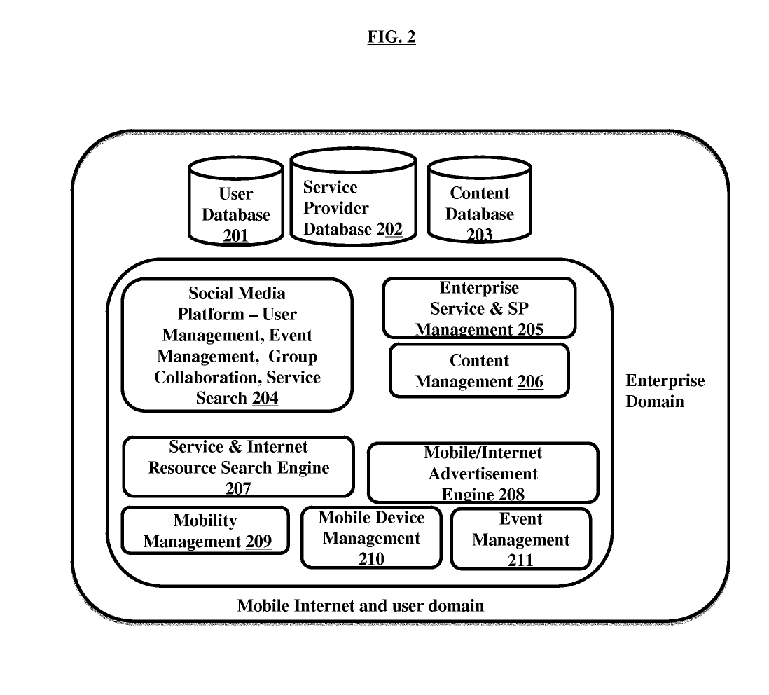

FIG. 2 depicts a SDP, according to embodiments as disclosed herein. The SDP 101 comprises of a user database 201, a service provider database 202, a content database 203, a social media platform 204, an enterprise service and service provider management module 205, a content management module 206, a search engine 207, an advertisement engine 208, a mobility management module 209, a mobile device management module 210 and an event management module 211.

The SDP 101 stores information about a user in a user database 201. The information for a user may be the name of the user, residential address, business address, interests and hobbies (watching movies, shopping, visiting restaurants etc). The user database 201 may comprise of both static and dynamic data and may be a database capable of persistent storage. The user database 201 may also comprise of the current location of the user, friends of the user, privacy preferences of the user, history of the actions and services taken by the user and so on.

The SDP 101 stores information about service providers in the service provider database 202. The information about the service provider 104 may comprise of name of the service provider 104, location of the service provider 104, services offered by the service provider 104, and available timings of the service provider 104. The service provider database 202 may also comprise of further specific information depending on the services being offered by the service provider 104. This information may be dynamic in nature. For example, if the service provider 104 is a cinema theater, the service provider database 104 may be constantly updated by the SDP 101 about the number of seats available in the cinema theater, on the basis of information provided by the cinema theater.

The content database 203 is used to store content related to the users as well as content/documentation as well as advertisements related to service providers.

The Social Media Platform (SMP) 204 is responsible for controlling the other modules present in the SDP 101. The SMP 204 is responsible for user management, event management group collaboration, service search and other functions performed by the SDP 101. The SMP 204 also keeps track of user movement and updates his location in the user database 201 in real time. The SMP 204 also allows a user to create closed user groups. A closed user group could be friends, users with similar interests, book club, special interest groups etc.

The Enterprise service and service provider management module 205 provides for management utilities that allow service providers and enterprises to integrate with the SDP and provide services to the users. The content management module 206 provides a unique content database and a management engine allows it to provide a solid repository for storing all the content related to the users as well as content/documentation as well as advertisements related to the service providers 104 in the content database 203.

The search engine 207 enables a user to search for a service based on several parameters and allows him to utilize the service easily. The parameters used by the user to search for a service may comprise of nature of the service, location of the user, availability of the service and so on.

The advertisement engine 208 is used to stream context based advertisements to the user. The advertisements may be fetched from the content database 203, with the help of the content management module 206.

The mobility management module 207 enables management of the mobility of individual Users, Closed User Group(s), location of static as well as mobile services. The module 207 also provides normalized location related algorithms in order to compute the normalized location of a service with reference to a group of users (CUG) or a single user.

The mobile device management module 210 provides device management capability in order to support adaptive content to suit the capabilities of the Mobile Device (Device Model, Device Type, and Smart phone vs. Feature Phone etc.) used by the user to access the SDP 101.

The event management module 211 allows users to perform event management within a single user or a multiple set of users connected logically or at least registered with the SDP Social Networking Site. The users are able to create Events, Modify Events and Delete Events. The SDP 101 then disseminates this event information via Internet to the user. The event management module 211 provides an ability to synchronize the local Calendar Object within the Mobile Device to update the events that were created by the user(s).

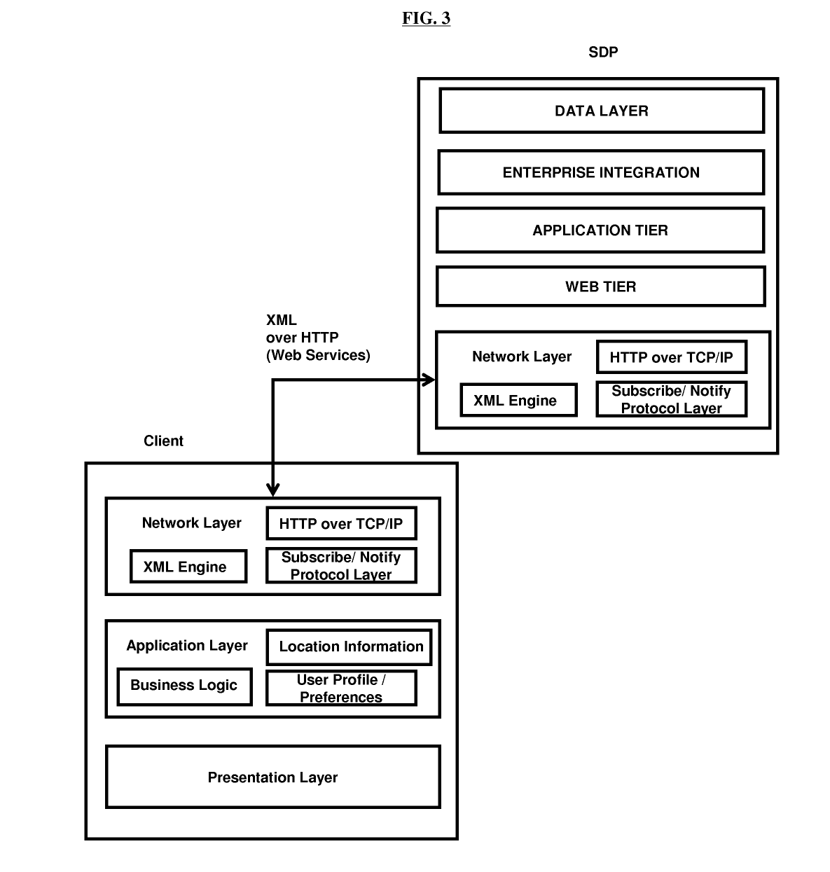

FIG. 3 depicts a communication link between the SDP and a client (a mobile device or a personal computer), according to embodiments as disclosed herein.

The communication implementation between a client and SDP 101 may be based on Event-driven, or Notification-based, interaction patterns, which are commonly used patterns for inter-object communications. Examples exist in many domains, for example in publish/subscribe systems provided by Message Oriented Middleware vendors, or in system and device management domains. This notification pattern is increasingly being used in a Web services context as well.

WS-Notification is a family of related white papers and specifications that define a standard Web services approach to notification using a topic-based publish/subscribe pattern. It includes standard message exchanges to be implemented by service providers that wish to participate in point to point notifications, standard message exchanges for a notification broker service provider (allowing publication of messages from entities that are not themselves service providers), operational requirements expected of service providers and requestors that participate in notifications, and an XML model that describes topics of subscription.

In an example environment, the client and SDP may provide XML engines and implement existing standard web service specifications for inter-communication.

### User Embodiments

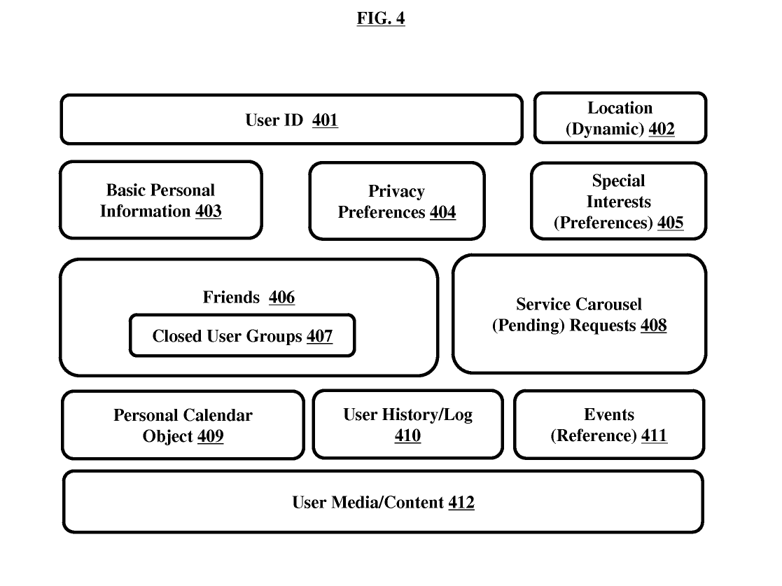

FIG. 4 illustrates a user profile, according to embodiments as disclosed herein. The user profile comprises of fields like user ID 401, location 402, personal information 403, privacy preferences 404, special preferences 405, friends 406, closed user groups (CUG) 407, pending requests 408, personal calendar object 409, user history 410, events 411 and user content 412. The user ID 401 comprises of the user ID, as created by the user at the time of registration. The user uses his user ID to access the SDP 101. The location 402 is a dynamic field and is updated with the location of the user. The location may be stored in terms of co-ordinates (latitude and longitude). The location may also be stored as a physical address, in terms of a street, area and so on. The location may also be stored with respect to a plurality of cellular base stations. The basic personal information 403 comprises of information of the user like the real name of the user, age, gender, marital status, phone number and so on. The basic personal information 403 may be optional for a user. The privacy preferences 404 enable a user to indicate how much of his personal details should be publicly visible. The user may also set how a service provider may contact him. For example, the user may want to hide his real name and address, but want to keep his age and gender public. The user may use the special preferences field 405 to indicate his interests. The user may be interested in watching movies, eating out and shopping. Advertisements to the user may be tailored according to the interests as indicated by the user here. The friends of the user are placed in the friend field 406. From among his friends, the user may create CUGs 407, which may have a common factor. For example, one CUG may comprise of friends of the user who went to college, while another CUG may comprise of his friends from his work place. The personal calendar object 409 comprises of events present in the calendar of the user. These events may be meetings, parties and so on. A replica of the personal calendar object 409 is also maintained at the user end. Any change made by the user at his end will be updated in the personal calendar object 409. Similarly, any change made by the user in the personal calendar object 409 will be reflected into the personal calendar object maintained at the user end. The event information in the personal calendar object 409 is also stored as a part of the user profile. Since events could be common to multiple users, event related information is stored separately in a cache but references to them are made available to the user profile objects or sessions. The exchange of information between the SDP 101 and the user end may happen using the web services notification architecture. Any services scheduled as a result of a request from the user is placed in the pending request field 408. The events from the personal calendar object 409 are updated into the pending request field 408. The user history field 410 stores the previous transactions of the user. This field may be configurable by the user. For example, the user may want to store his history for the past two weeks or he may want to store his past twenty transactions as history. The reference events field 411 contains references to all those events that were either created by the user or events that the user was part of as a participant even when created by others. The user content 412 is a storage area, where the user can store media. The media may be videos, pictures, text or any other media. The media may be shared by the user within his social network. The user may also configure his settings such that the media is shared with only a CUG within his social network.

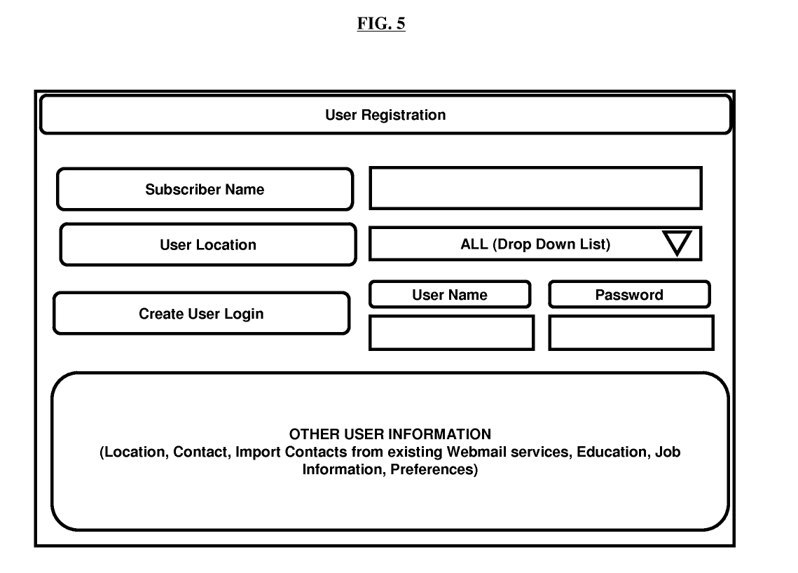

FIG. 5 shows an example user registration using which a user registers himself on to the social media platform according to various embodiments herein. Apart from the basic information like subscriber name, location of the user, and user login details, the registration may also collect other information that may be useful to build a user's profile as illustrated in FIG. 4.

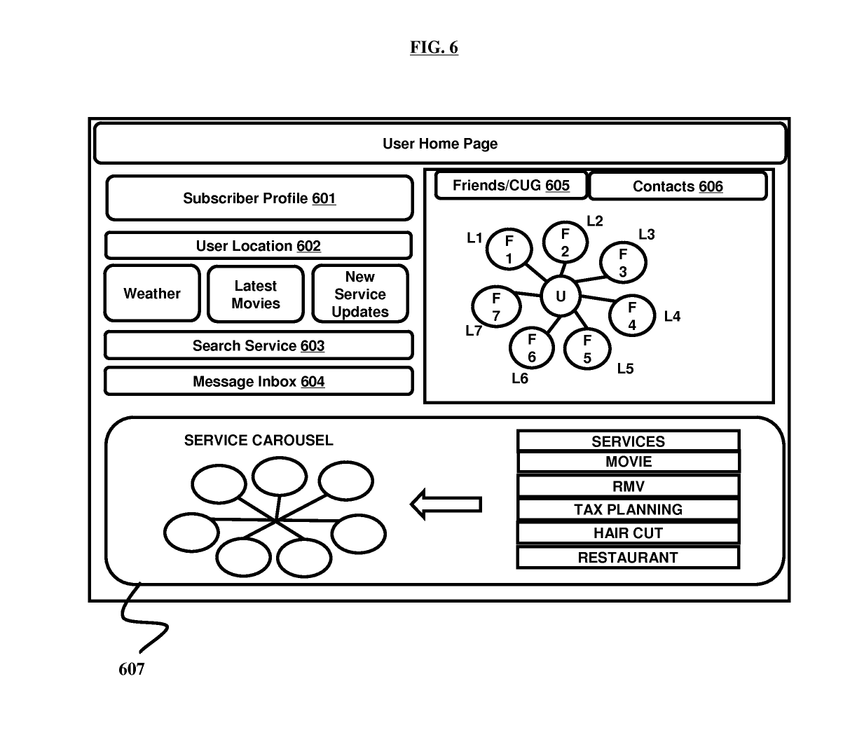

FIG. 6 shows user home page as seen on a client like a web browser according to various embodiments herein. The user home page is the first page that a User sees every time he logs in after his initial registration into the social platform. Using the subscriber profile tab 601, a user will be able to view/edit his profile and change any preferences based on his current interests and needs. User may also dynamically update his Mobile Location using the user location tab 602 onto the SDP. User may also choose to provide access to others about his real-time location using a configurable option to ON/OFF access privileges. Further, a user may also search a service using the search service tab 603 based on a certain set of criteria. The services that a user may search may include services which are registered via a Service provider using the SDP, and third party services which allow exposing their services using Web Services (SOAP or REST API). Furthermore, a user may also use the service carousel 607 which allows him to push services that he would like to consume within a 24 HR or 48 HR. The time limit within which the user would like to consume services that he drags onto the service carousel is configurable. A user may search for available services and can choose services to be placed on to his service carousel 607. A user may also use a predefined list of services presented based on his preferences and choices to select services to be placed in the service carousel 607 for consumption. Still further, a user may interact with other members in Contact List 606 or CUG 607 to arrange for an Event or gathering or consume a particular service together (for example, get together in a restaurant).

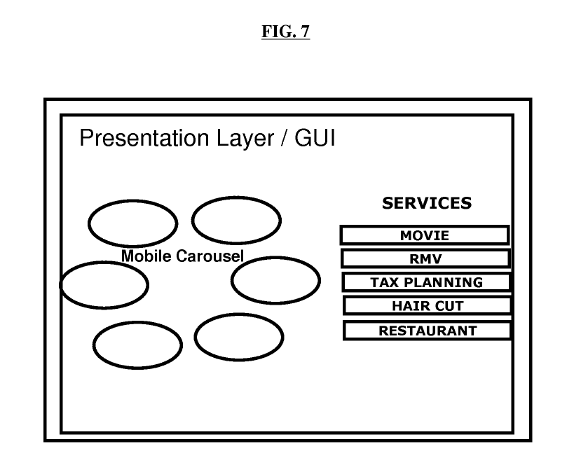

FIG. 7 shows an example home page as may be visible on a mobile screen according to various embodiments herein. Due to lesser amount of screen space available for mobile screens, a user home page on a mobile device may only have the service carousel 607 for users to drag and drop services that they wish to consume in a configured amount of time onto their service carousel. However, there may be other mobile devices (like smart phones) that may allow larger screen space. The SDP may present a different home page depending on the device that is requesting the information and depending on the available screen space for the device that is requesting information.

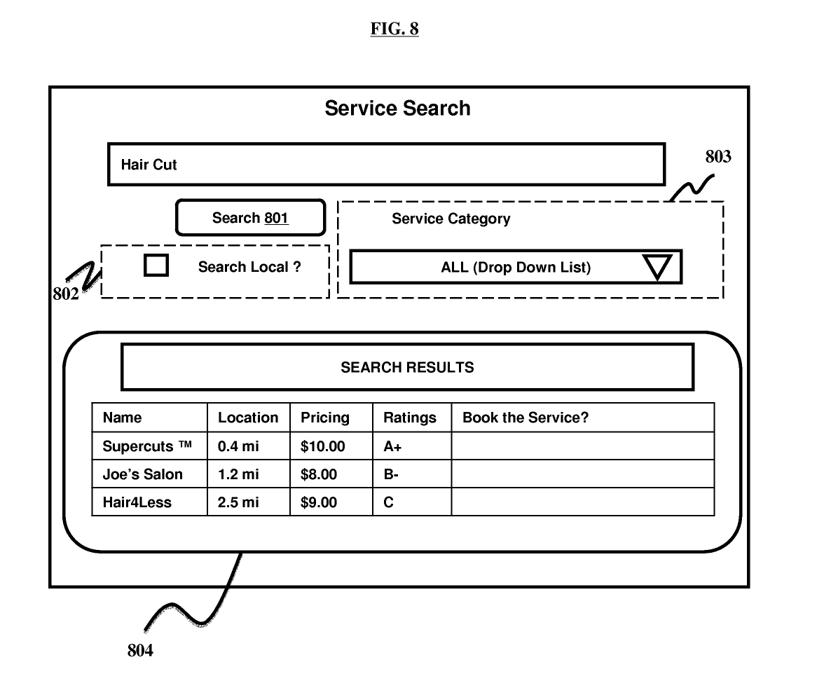

FIG. 8 shows an example service search page according to various embodiments herein. A user may search for services that include the services which are registered via a Service provider using the SDP, and third party services which allow exposing their services using Web Services (SOAP or REST API). A user may choose to restrict the services being searched to services available locally in his location based on his user profile information. User may restrict services to local services using the option 802. A user may also restrict services to a particular category by choosing the options provided in category section 803. After choosing the options 802 and 803, a user may enter the key words related to a service and click on the search tab 801 to obtain search results. The search results obtained based on the criteria selected can be viewed in the search results section 804. The SDP allows for users to plan for and consume services. When users consume services, users are presented with options to rate the services that they have consumed. Such ratings will be useful to other users in evaluating the services before they consume those services. In the search results section, the average ratings associated with a service is also presented for each service listed in the results. This will help the user to evaluate the best service based on his preferences and choose an appropriate service for consumption. A user, after evaluating the various services presented to him, could choose one or more services for consumption using the book option.

In various embodiments, the search Database at the SDP is indexed with all the registered information by the various service providers as well it has indexed the data made available by several third-party business listings or Yellow Pages™ etc. For example, search data at the Search Database of the SDP may be indexed by Service Name, Service Category (Restaurant, Library, and Beauty Care etc), Service Location, Service Pricing, and User Ratings of a Service among other parameters.

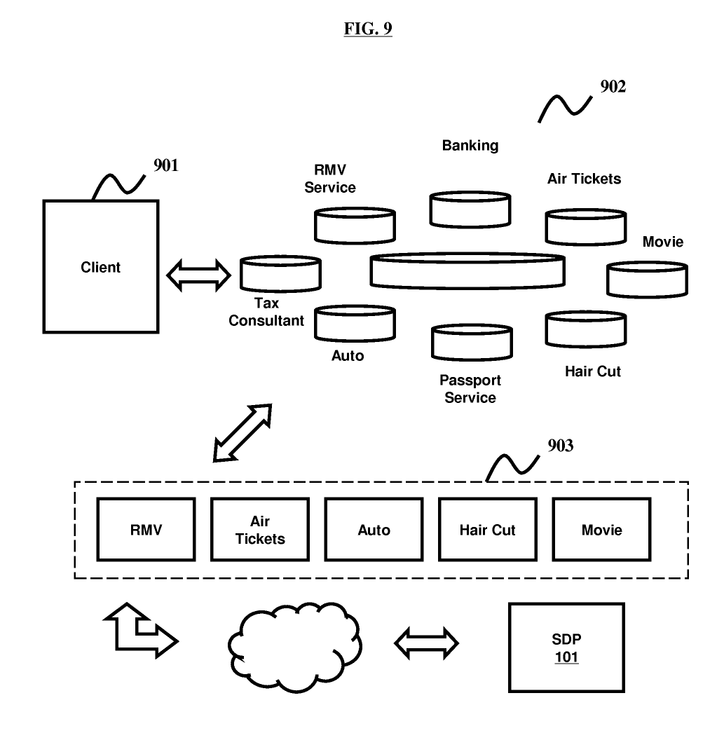

FIG. 9 illustrates the queuing of services by the service carousel before sending the request to the SDP. A user, using his client, may choose any number of services for consumption, to be consumed within a configured period of time. Based on user's choices, the client places the chosen services 902 on to the service carousel 607. The service carousel then builds a queue of services 903 for the SDP to schedule the services. The SDP then uses the user profile information and the calendar information to schedule the consumption of services. For example, if a user has planned to visit location X at 5 pm, and if the user's preferences state that the user generally visits for hair cut at 6 pm, then SDP may try to schedule a visit to hair cut at a place near to the location X. However, if the user chooses to only visit a particular hair cut saloon, then the SDP may try to schedule the hair cut visit at a later date based on user's preferences for that service. Similarly, SDP may also choose a particular cinema based on user's preferences in terms of types of movies that he is interested, cinemas that he would like to visit and so on. Using such user preferences, SDP presents options to the user. User selects one of the presented options for consumption.

### Service Provider Embodiments

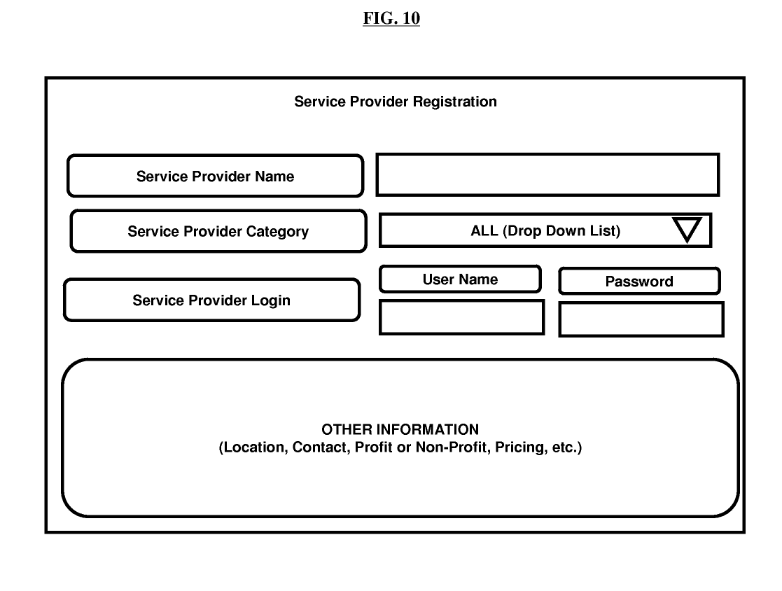

FIG. 10 shows an example service provider registration page as can be viewed on a client like a web browser on a personal computer. A service provider may register by entering information into the system using the service provider registration form as illustrated in FIG. 10. Apart from providing basic information like the service provider name, category to which the service provider belongs, and the login credential information, a service provider can also add other information including but not limited to location, contact information, other details of the business like offerings and value addition, marketing collateral including pricing information, and so on.

Multiple locations can be registered into the same Service Provider by using Location ID (Location name & a unique location id will be automatically assigned by the system). For example, when a particular service provider operates as a franchise, one administrative headquarter can be authorized to add the Service Provider Registration information into the SDP system. Further, the SDP system presents customized Web page content for each of the franchise centers and shows only relevant information for Service Management and User Management screens. The SDP has a Web Server engine and content management system which allows the web page content to be adapted to the specific needs of a business location by masking all the irrelevant information related to its Service Headquarters etc.

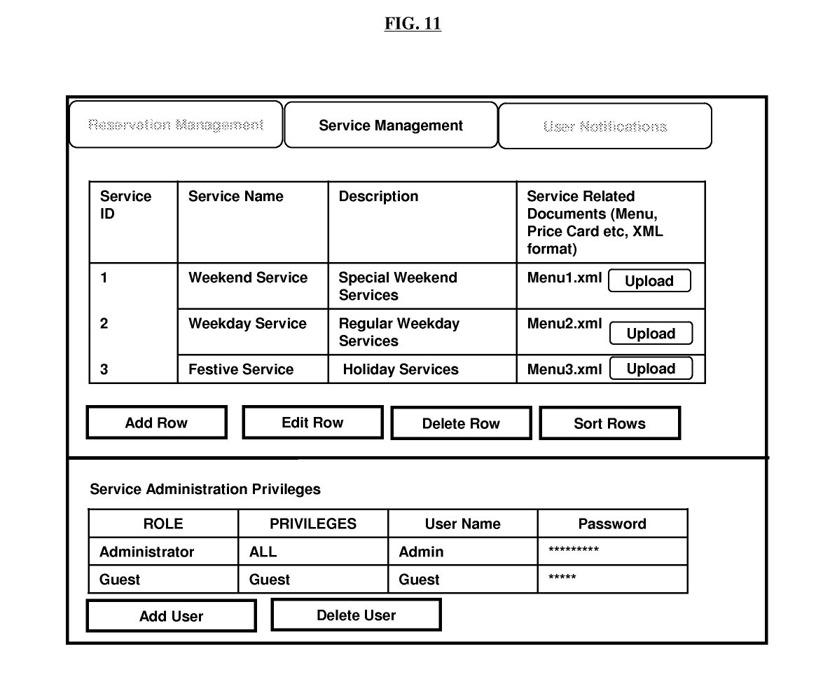

FIG. 11 shows an example service management interface provided for a service provider. FIG. 11 shows the service management interface for a restaurant. A service provider may add multiple services that the provider offers. For example, in the case of a restaurant, the service offerings (in the form of the menu items) may change depending on the day of the week and seasons. A restaurant may offer different menu during the weekends compared to the menu on weekdays. Similarly, a restaurant may offer different menus during different festive and holiday seasons. A restaurant may add multiple service offerings and upload corresponding menu details through in XML format through the service management interface provided to the service providers. A service provider may change his service definitions using the interface. He may add new services, delete existing services, or edit existing services by changing name, description, or menu selections. SDP 101 automatically indexes the services uploaded on to the system immediately to ensure that new services uploaded onto the system are immediately available for search for users.

Apart from defining services offered by a service provider, a service provider may also manage user privileges using the service management interface. For example, the management of a restaurant may want to give a certain number of users of the system the rights to change the service definitions and related information. It may want other users only to view the information and not change the service definitions. The system allows service providers to create multiple users and assign specific rights to each user based on his role. As an example, a service provider may create an administrator user that can change all information relating to the service provider. As another example, a service provider may also add a guest user who could only view information, and cannot make any updates to the existing information or make any new entries.

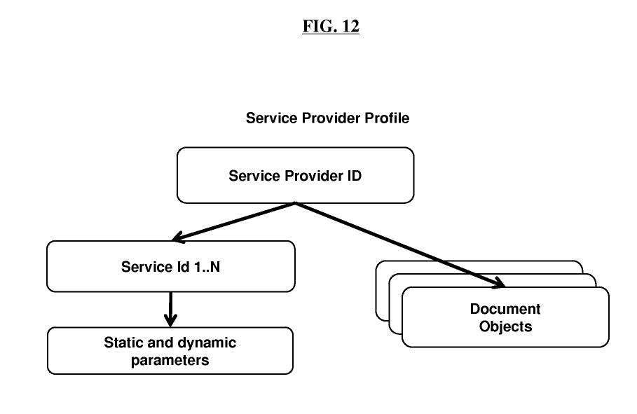

Using the information from service provider registration and service management, SDP builds a service provider profile as illustrated in FIG. 12. Each service provider will have a unique service provider identification (or ID). All information relating to a service provider is associated with the corresponding service provider ID. For example, a service provider may have N services listed under his profile. Each service will be associated with the unique service provider ID. Similarly, all parameters being tracked and indexed for the service provider are related to the corresponding service. And, therefore, each parameter can be linked to the unique service provider ID using the service that is attached to the service provider. Further, all documents and objects (like the menu, marketing collateral etc) are also directly attached to the service provider (through the unique service provider ID) or the service (using the service ID) depending on the nature of the document or object.

### Reservation Management Embodiments

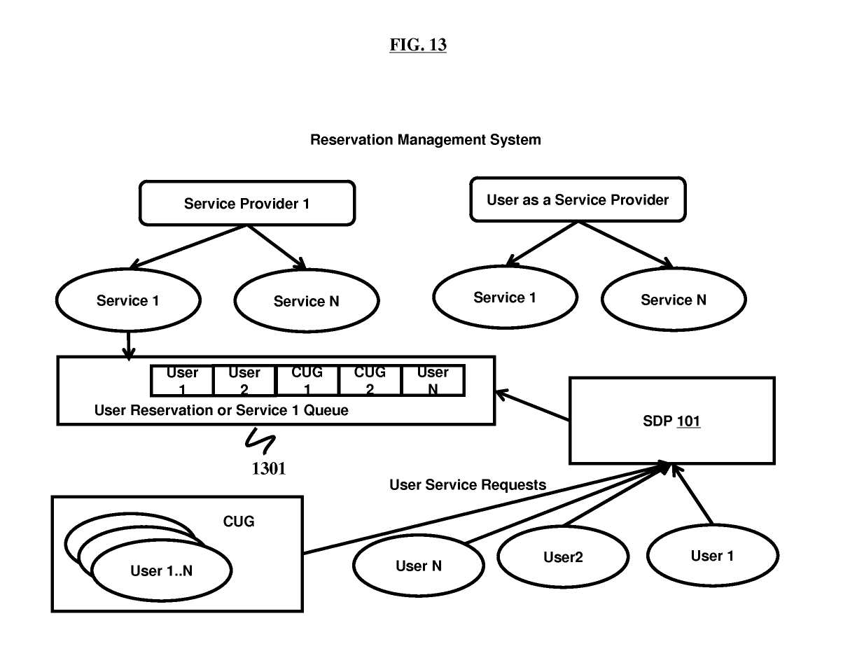

The SDP 101 provides an inherent Reservation management system which allows the Service providers to have its Service Users use this system to reserve for the services provided by the Service provider. FIG. 13 illustrates use of the SDP 101 to reserve for services. Users belonging to a CUG or otherwise can search for services and request for reservation for services that require reservation. For example, a service that may require prior reservation would be a restaurant. When a user or a group of users request for reservation with a particular restaurant, the SDP 101 recognizes the request. The SDP 101 uses the request information and passes on the reservation request to the corresponding service provider.

In various embodiments, the SDP 101 automatically figures out whether the request is for a CUG or for an individual and correspondingly passes on relevant information in terms of number of users and expected time of arrival for consumption. For example, if an individual user is requesting for reservation, the system only needs to take into account his current location and the time it might take for the user to reach the location of the service provider. However, it the request is from a group of users such as a CUG, the SDP 101 needs to figure out a normalized location and figure out the time the group might take to reach the location for consumption of service.

Further, in recommending a service provider (for example, restaurant) to a group of users such as a CUG, the SDP 101 system may take into account normalized location of the business with respect to each user of the group. The SDP 101 uses information gathered from a Location Server about the various users' location information by getting the physical location coordinates and computes at run time the normalized location(s) of a business or a place of service based on the location coordinates of the CUG users as well as the location(s) of the business(es). The normalized locations are computed on several parameters including but not limited to the type of business they want to engage with (for example, Chinese restaurant or Japanese Restaurant or Italian Restaurant), wait time of the business/service, pricing preferences of the user or the closed user group, and user ratings of the business or service or star rating of the service among others.

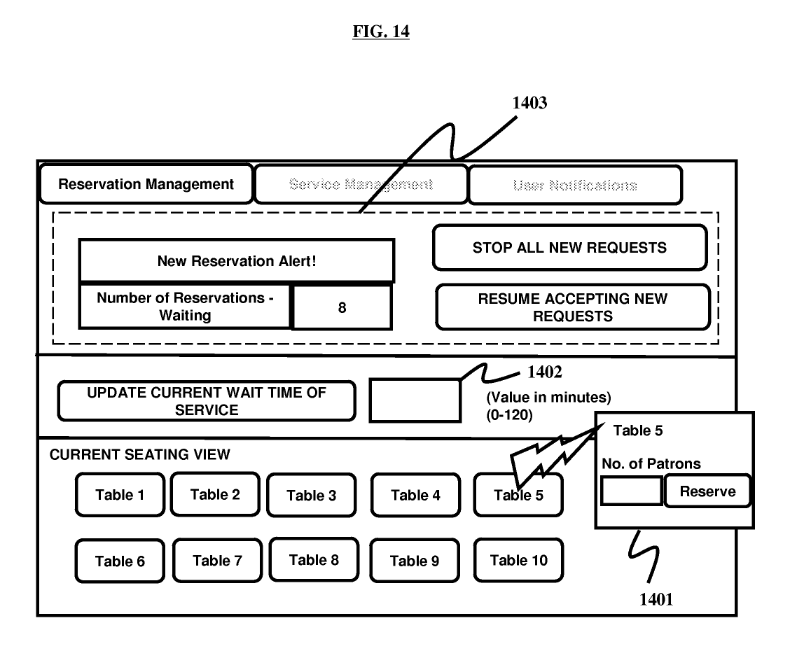

Based on the request received through SDP, the reservation management system builds a queue 1301 of the requests for the service 1 as illustrated in FIG. 13. The service provider 1 may use reservation management interface provided to accommodate requests or reject requests based on his current business supply and demand conditions as illustrated in FIG. 14. The service provider may allocate a particular request to a particular table 1401. The service provider may also update the current wait time 1402. The current wait time is an example of a dynamic parameter that will be indexed by the SDP 101 system and will be used in presenting search results for services when requested by users. The service provider will also be able to view the number of pending reservation requests 1403. Based on the current supply and demand conditions for the service, the service provider may request to stop all new requests (for example, when the business is too busy and there will be no free tables). The service provider may also start accepting requests again once the demand eases down after some time.

FIG. 14 shows a flow diagram illustrating message flow when users of a CUG coordinate to reserve a restaurant service. In step 1501, one of the leads from the Closed User Group uses the Mobile Application to initiate a search request to find and reserve a restaurant of the right choice and intends to involve his Closed User Group for the same. In step 1502, the User 1 initiates communication with the rest of the CUG members using the messaging platform provided by the SDP's social network component. In step 1503, a request from User 1 goes to the SDP about booking a restaurant using the SDP services module—SDP receives a request for a restaurant booking, in this case let us assume that the users choose Italian as the Restaurant Type. In step 1504, the SDP processes the request by finding out the location of each of the CUG members from the Location Database and arriving at a normalized radius for location based search of the restaurant, and searching for all Italian restaurants within the computed normalized radius. In step 1505, the SDP presents the User 1 the top 3-5 choices of restaurants based on the Normalized location of the Closed User Group. Although Normalized location is computed based on the physical coordinates of the individual members of the Closed User Group, additional parameters are taken into consideration like traffic conditions, location affinity selection of the CUG, User preferred Price Sensitivity, and Server Selected User Rating of the Restaurant among others. Most importantly the wait times of each of the Restaurants are presented to the CUG. (Wait Times are regularly updated by the Service Providers (restaurants etc.) on a regular basis or a historic wait time patterns are applied as illustrated in FIG. 14). In step 1506 the CUG after discussing mutually in Real-Time select a Restaurant of their choice. A request is sent to the SDP. In step 1507, the SDP forwards this request to the selected Service provider (Restaurant) about the reservation for the CUG. It is important to note that the message propagated by the SDP towards the Service Provider about the Restaurant Reservation Request pops up at the Free Web Front-end provided by the Solution to the Service Provider. In step 1508, the Restaurant Console Administrator either accepts or declines the Reservation request. Here we assume that the Restaurant (Service provider) has accepted the request for the reservation from the CUG. After accepting the reservation in the SDP, in step 1509, automatically publishes the Restaurant Menu document which was earlier submitted by the Service Provider (Restaurant) to all the CUG members. The CUG members once again use the Instant messaging platform provided by the SDP, to discuss the Menu selection in Real-Time. Once the Menu has been selected, the User 1 then initiates another request 10 to the SDP about the selection of the menu for the selected Restaurant. In step 1511, the SDP transmits the menu selection request with the selected menu items to the Restaurant. In step 1512, the restaurant console administrator confirms about the selected menu and sends a response acknowledging a successful processing of the Menu items selected by the CUG. Between 1511 and 1512, as an optional capability, the SDP also allows payment processing of Credit card by storing such information on file for the CUG members or by requesting/prompting to enter new payment method information by the CUG member(s), user 1 in this example. In 1513, the CUG gets a FINAL Confirmation about their Restaurant Menu selection and they are cleared to proceed to the restaurant to dine in.

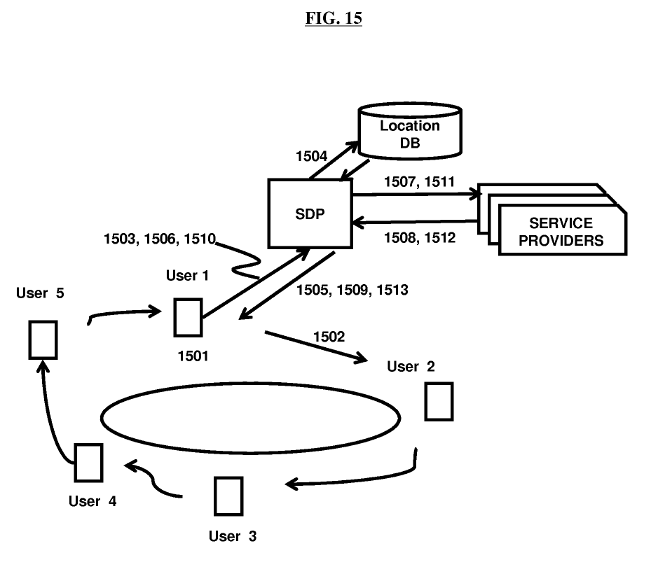

The various actions illustrated in FIG. 15 may be performed in the order presented, in a different order or simultaneously. Further, in some embodiments, some actions illustrated in FIG. 15 may be omitted.

### Event Management Embodiments

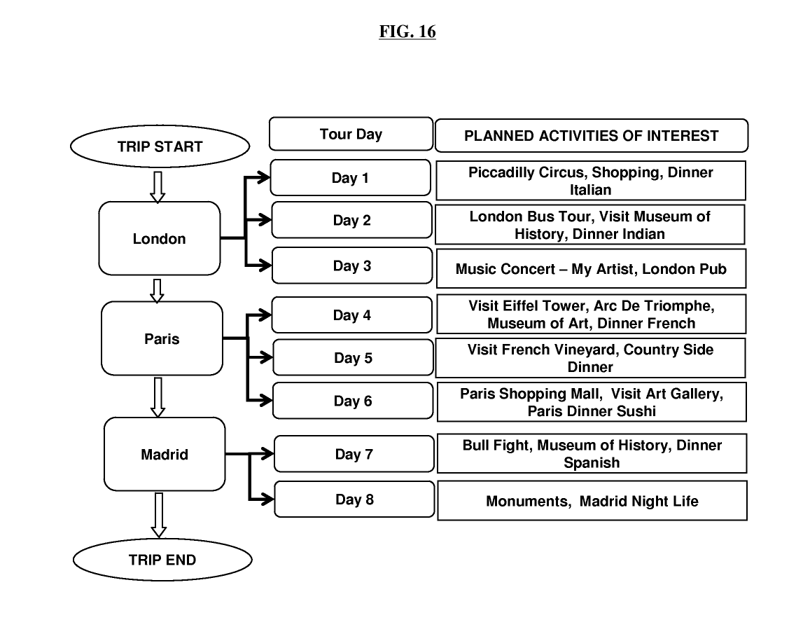

In some embodiments, the SDP 101 system may be used to plan events like trips. FIG. 16 illustrates a trip plan that can be prepared either by a user for himself or on behalf of a CUG. Using the SDP, user or a CUG is able to use the Web Interface along with a Wizard Form to plan a tour, for example a trip to Europe. Trip planning may be provided as one of the services along with other services through the SDP platform. The SDP provides an Interface (accessible through a personal computer or a mobile device) which allows the User(s) to plan a trip while using the Social Networking platform.

The interface provides a Wizard like interface which allows the Users to enter data in a structured and semantic way, and define their trip plan and the associated activities in each day of the trip as illustrated in FIG. 16. The data output from the trip plan results in the scheduling of multiple service search requests implicitly at the SDP platform which searches for all the registered and non-registered services in the respective cities (London, Paris & Madrid). The SDP platform after searching and finding the most relevant results based on several preset criteria by the users like Travel Budget, Popularity of the Service to be consumed etc. Most importantly the SDP provides the user several options to select for consuming a service either upfront or by working behind the scenes. The users have ability to select an option of their choice and make it part of their itinerary.

As illustrated in the example, users are able to interact with the system, notify what their preferences, retrieve the results they desire, and then finally make the choices part of the Travel Itinerary. Once the final choices are made, the entire trip plan is then populated into the User's or CUG's Calendar (which ultimately reflects in the calendar of each user of the group) and allows him to view all information related to his trip on his Mobile device or personal computer since the SDP pushes the changes to the calendar on the SDP to the calendar object residing in the User's Mobile or personal computer. This process also automatically inserts alerts for all the important events during the Trip.

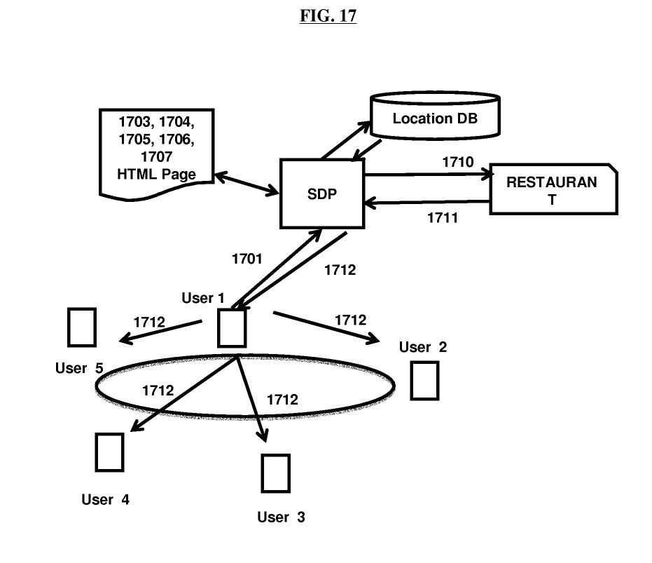

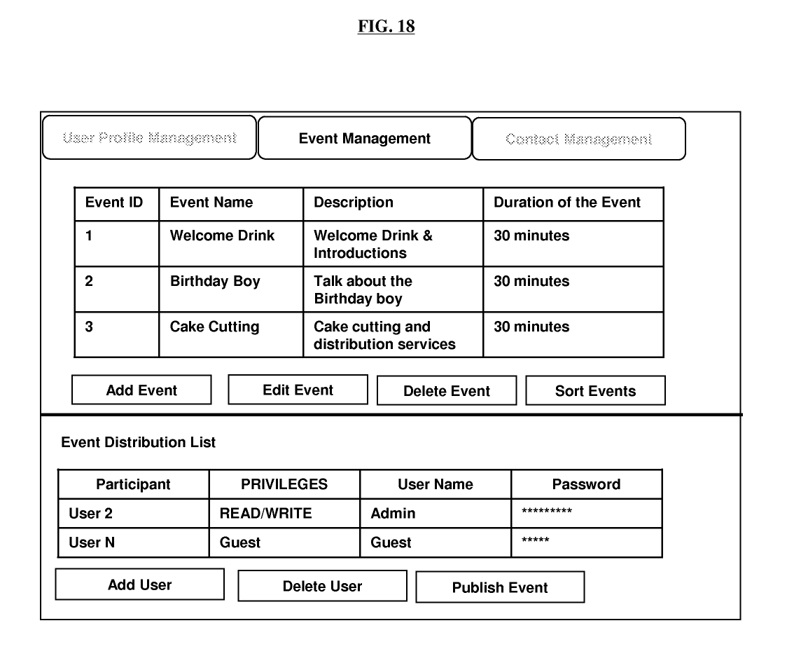

In some other embodiments, the SDP system may be used for event management for an event like a birthday party among a group of users. FIG. 17 shows a flow diagram that illustrates the coordination among a group of users in managing an event, in this example a birthday party. FIG. 18 shows the event management page that can be used to plan an event like a birthday party.

In step 1701, User 1 who is part of either a CUG or custom selects a set of contacts from his Social Networking profile located at the SDP Server, and decides to plan for a Birthday Party to this selected set of friends. It is important to note only User 1 gets to modify or delete the events that were created by him The SDP however provides him the privileges to provide either Read-Only access (by default) or Write access to one or more of the CUG members or contacts from this Social event hosted as part of the SDP. In step 1702, as he is already logged in into the Social Networking site hosted as part of the SDP, the user selects to create a series of events as part of the Birth day party. To create an event, the User may define the Event Type, the Event Name, Event Date and overall Event Duration among other details. The wizard in the SDP Social Web Server provides ability to create independent sub-events (or events) and then later combine them to form a larger event like a Birthday Party or Marriage Party etc. The series of steps that the User 1 follows in order to create and define multiple events and then later combine together is his own choice. In step 1704, Let us assume that User 1 decides that he will host a welcome drink and introduction session (sub-event) called E1 for half hour as the party members arrive at the Party venue. In step 1705, in E2 sub-event, User 1 decides that he will make an announcement of the Birthday Party and allow party goers to talk about the Birthday person and their experiences about him or her for half hour. In step 1706, in E3 sub-event, the User 1 decides to have the Cake Cutting ceremony to take place for 15 minutes followed by distribution of the cake & Snacks. In step 1707, E4 sub-event, he decides to invite the entire party to start with the Dinner and he makes the Drinks announcement, which may be planned to continue for 1.5 hours. In step 1708, E5 sub-event, he decides to provide return gifts to the party attendees and then declare with any closing announcement about the Party or any instructions thereof.

The sum of all the events may comprise of the actual Party as a whole. In this example, the birthday party event E=E1+E2+E3+E4+ . . . +En, where En is the nth event defined for this party and is also the last event defined for the party. The total duration (ET) of the Party E is equals to the sum of duration of the individual events. (ET=E1T+E2T+ . . . +EnT)

In step 1709, after creating all these independent sub-events (or events), the User 1 has the ability to reshuffle them in any order that he desires to and then create a final event of his choice. In step 1709 he can actually review the list of all Party attendees that he selected and then finalize the same. User 1 may also modify the party event flow and reshuffle them even until the end of the party schedule.

In 1710 and 1711, the SDP platform provides the User 1 with facility to purchase party supplies, order a cake of his choice, select a venue of his choice, Order food for catering, select printed Birthday invitations of his choice and place and order for the same while he is online & a plethora of things that he could achieve as a one-stop kind of solution from where he is able to plan and arrange an entire party.

It is important to note that most of these Service providers like Party Suppliers, Bakeries, and Food Catering, Party Venues, and Custom Printing Solutions providers are already part of the SDP platform as Service providers or provide access to their services using popular Web Services API.

The SDP uses the various business rules to provide only the most relevant Service providers of User 1 choice based on his location, his pricing preferences, his favorite Store preference and many such parameters. In step 1712, he uses the Publish button to publish the event to all the members of the Social Network that he has selected. Further, since all the members of the Social Network are part of the SDP that the User 1 has created the event from, the SDP allows the propagation or broadcast of the birthday event as a Calendar Item that goes to either the Mobile Calendar Object or arrives in an E-mail or the Inbox of the Social Network profile of each of the list of attendees that the User 1 has selected.

It is very important to note that while the Event Management applied here is so popularly used amongst the public internet users, at the same time our invention does not limit the usage of the Event Management to Social Networking users in the Public domain. The SDP system allows Enterprises with Private Intranets to register themselves into the SDP while the SDP provides various levels of access control and security that they are able to use the Event Management Infrastructure to conduct meetings and organize corporate events of their choice in a private and discreet manner without the users in the Public Internet knowing about such events or meetings.

Furthermore, the Event Management additionally provides several Multimedia Capabilities like Live Document Sharing, Whiteboard applications while in a meeting, Group Audio Conferencing and Group Video Conferencing.

A combination of Content Management System plus the Session Management System will allow such extensive feature capability using the standard internet protocols of choice like SIP, RTP with Video encoding capabilities for SD (Standard Definition), HD (High Definition), and for VoIP and Video Control signaling.

The embodiments disclosed herein can be implemented through at least one software program running on at least one hardware device and performing network management functions to control the network elements. The network elements shown in FIG. 3 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method of enabling integrated activity scheduling using a social network platform comprising
selecting a service by a user;
pushing said selected service to carousel by said user; and
adding said selected service to said user's schedule automatically.

2. The method as in claim 1, wherein adding said selected service to said user's schedule is based at least on user preferences, user group preferences, location of service, and said user's existing schedule.

3. The method as in claim 1, wherein schedule is a day calendar

4. The method as in claim 3, wherein said activity is a service consumption activity.

5. The method as in claim 1, wherein schedule is an event calendar.

6. The method as in claim 5, wherein said activity is an event management activity.

7. The method as in claim 1, wherein selecting a service further comprises of specifying an activity by said user; and suggesting one or more services by said platform.

8. The method as in claim 1, wherein selecting a service further comprises searching for services by said user.

9. The method as in claim 1, wherein selecting a service further comprises of user specifying preferences based on at least one parameter, where said at least one parameter is one among a group of static and dynamic parameters; and suggesting one or more services by said platform based on said preferences.

10. The method as in claim 9, wherein a static parameter is one among Type of Business, Cost of Service or Product, Vicinity of the Location of the Service, User Preferred Time of Consuming a Service, User Preferred Time of Delivery of a Product, Previous History, Stored Preferences of the User, Service Rating as given by a group of Users/Consumers, Product Rating as given by a group of Users/Consumers, Service Rating as given by an independent Analyst, Product Rating as given by an independent Analyst, and Published Wait Time of a Service.

11. The method as in claim 9, wherein a dynamic parameter is one among Relative Positions of each User as part of a Closed User Group that wants to consume the Service as a group, Traffic Conditions that affect a Mobile User's arrival at a location of Service, Business Hours associated with a Service with respect to the time of the Day, and sudden spike in demand for a service that leads to extensive wait time for Service delivery and that conflicts with the User's preferred time of consuming a service.

12. A method of enabling integrated services in a social network platform comprising
suggesting relevant services by said platform based on at least one parameter;
selecting a service by a user;
pushing said selected service to carousel by said user; and
adding said selected service to said user's schedule automatically.

13. The method as in claim 12, wherein schedule is a day calendar

14. The method as in claim 13, wherein said activity is a service consumption activity

15. The method as in claim 12, wherein schedule is an event calendar.

16. The method as in claim 15, wherein said activity is an event management activity

17. The method as in claim 12, wherein said parameter is a static parameter.

18. The method as in claim 17, wherein a static parameter is one among Type of Business, Cost of Service or Product, Vicinity of the Location of the Service, User Preferred Time of Consuming a Service, User Preferred Time of Delivery of a Product, Previous History, Stored Preferences of the User, Service Rating as given by a group of Users/Consumers, Product Rating as given by a group of Users/Consumers, Service Rating as given by an independent Analyst, Product Rating as given by an independent Analyst, and Published Wait Time of a Service.

19. The method as in claim 12, wherein said parameter is a dynamic parameter.

20. The method as in claim 19, wherein a dynamic parameter is one among Relative Positions of each User as part of a Closed User Group that wants to consume the Service as a group, Traffic Conditions that affect a Mobile User's arrival at a location of Service, Business Hours associated with a Service with respect to the time of the Day, and sudden spike in demand for a service that leads to extensive wait time for Service delivery and that conflicts with the User's preferred time of consuming a service.

21. A method of interacting with a service provider through a social network platform, said method comprising
uploading business information by said service provider based on at least one parameter, where said at least one parameter is one among a group of static and dynamic parameters;
suggesting services from said service provider by said platform to a user based on said at least one parameter; and
rendering said business information by said platform upon request from a user.

22. The method as in claim 21, wherein a static parameter is one among Type of Business, Cost of Service or Product, Vicinity of the Location of the Service, User Preferred Time of Consuming a Service, User Preferred Time of Delivery of a Product, Previous History, Stored Preferences of the User, Service Rating as given by a group of Users/Consumers, Product Rating as given by a group of Users/Consumers, Service Rating as given by an independent Analyst, Product Rating as given by an independent Analyst, and Published Wait Time of a Service.

23. The method as in claim 21, wherein a dynamic parameter is one among Relative Positions of each User as part of a Closed User Group that wants to consume the Service as a group, Traffic Conditions that affect a Mobile User's arrival at a location of Service, Business Hours associated with a Service with respect to the time of the Day, and sudden spike in demand for a service that leads to extensive wait time for Service delivery and that conflicts with the User's preferred time of consuming a service.
